(19) United States
(12) Patent Application Publication
(10) Pub. No.: US 2014/0357893 A1
(43) Pub. Date: Dec. 4, 2014

(54) RECOVERY FROM ROCK STRUCTURES AND CHEMICAL PRODUCTION USING HIGH ENTHALPY COLLIDING AND REVERBERATING SHOCK PRESSURE WAVES

(71) Applicant: Altmerge, LLC, Colorado Springs, CO (US)

(72) Inventor: Bruce H. Peters, Colorado Springs, CO (US)

(21) Appl. No.: 14/294,383

(22) Filed: Jun. 3, 2014

Related U.S. Application Data
(60) Provisional application No. 61/830,666, filed on Jun. 4, 2013.
(60) Provisional application No. 61/847,830, filed on Jul. 18, 2013.

(51) Int. Cl. F27D 7/06; B01J 8/00; E21B 43/28

(52) U.S. Cl. CPC F27D 7/06; E21B 43/28; B01J 8/008; F27D 2007/063
USPC 564/63; 299/5; 432/219; 432/25; 423/352; 423/396; 423/390.1; 422/198

(57) ABSTRACT

An example system includes a combustion chamber including at least one inlet and at least one outlet, and at least one reflective surface to direct shock waves in a pattern that meets at a midline nodal point. The example system also includes an ignition source to generate high enthalpy colliding and reverberating shock pressure waves and detonation gasses for dynamic pressurization. An example method for using high enthalpy colliding and/or reverberating shock pressure waves for chemical and material processing. The example method includes providing a combustion chamber including at least one inlet and at least one outlet, and at least one reflective surface to direct shock waves in a pattern that meets at a midline nodal point. The example method also includes colliding reflected or opposing combustion-induced or detonation-induced wave fronts within the combustion chamber.

### PRIORITY CLAIM

This application claims the priority filing date of U.S. Provisional Patent Application No. 61/830,666 filed Jun. 4, 2013 titled “High Enthalpy Shock Pressure Waves From Intermittent Gas Collisions” of Bruce H. Peters, and U.S. Provisional Patent Application No. 61/847,830 filed Jul. 18, 2013 titled “Systems And Method of Petroleum And Other Recoveries From Rock Structures,” each hereby incorporated by reference for all that is disclosed as though fully set forth herein.

### BACKGROUND

Industrial chemical and materials processing commonly utilizes extreme pressures and temperatures for processing and reaction mechanisms. This is typically done through the application of static pressures on liquids, gases, and solids with or without extreme temperatures for the purpose of altering, combining, or breaking molecular bonds and compositions for the formation of commercially desired products. Industrial autoclaves are examples of such use and for example perform tasks from sterilization of poultry to ammonia synthesis in Haber Bosch reactors.

Recoverable underground petroleum is found in sandstone, shales, and carbonate structures like limestone and dolomite. All can be fissured by detonative force, but the 60% of petroleum in the carbonates is the most difficult and is variable in porosity making economic recovery difficult. One aid is putting an acid, like hydrochloric acid, into the structure to create pathways by chemically etching thereby creating pathways to improve flow. Carbon dioxide may then be pumped in, under pressure, to deform the rock and lift the freed petroleum to the surface.

### BRIEF DESCRIPTION OF THE DRAWINGS

FIGS. 1A-E illustrate cross-sectional views of example resonance combustion chambers.

FIGS. 2A-C illustrate cross-sectional views of an example opposed twin combustion chamber.

FIG. 3 illustrates an example ignition system having a plurality of igniters configured to fire sequentially in either a clockwise or counterclockwise orientation.

FIG. 4 illustrates a cross-sectional view of another example combustion chamber.

FIG. 5 illustrates an example of the system implementing hydraulic fracking and loosening of oil and gas deposits in the earth.

FIG. 6 is a process flow diagram illustrating an example method which may be implemented by the system described herein.

### DETAILED DESCRIPTION

Systems and methods are disclosed to provide static gas pressure further energized by shock waves, and augmented by in-situ production of acids. The systems and methods combine the features of both pressure with rock spalling shock waves to create proppant, and chemical etching in a combined process to enhance oil recovery.

The systems and methods are based on use of colliding shock wave forces (to increase pressure) and reverberating forces (to prolong pressure). In actual practice, a device combining and directing the forces of two detonations colliding with each other has resulted in a four-fold increase in ammonia production and a demonstrable increase in the force of the shockwave energy produced.

In an example, the systems and methods are described herein which produce nitric acid in situ and add it to a subterranean shock wave, along with high pressure steam in order to recover petroleum from carbonate and other hydrocarbon containing rock structures.

Continuous operation modifies detonations to produce an ammonia product practically by taking advantage of the Le Chatelier principle. For high efficiency, the ammonia production step can be accomplished with high to maximal pressure, and low to minimal temperature. A subsequent step of combining ammonia with carbon dioxide can be accomplished at high to maximal temperature under low to minimal pressure.

The systems and methods employ high enthalpy shock pressure waves from intermittent collisions of combustion-induced or detonation-induced gas wave fronts to output an elevated velocity exhaust.

Combine static pressures of hydraulic fracking and the shock of propellant fracking, disclosed systems and methods loosen oil and gas deposits from down-hole steam technologies in a single, simple, and cost-effective solution. Additional benefits include, but are not limited to, environmentally friendly processing, minimal water consumption, little or no emissions and reduced or even chemical-free operation reducing the risk of groundwater contamination.

Before continuing, it is noted that as used herein, the terms “includes” and “including” mean, but is not limited to, “includes” or “including” and “includes at least” or “including at least.” The term “based on” means “based on” and “based at least in part on.”

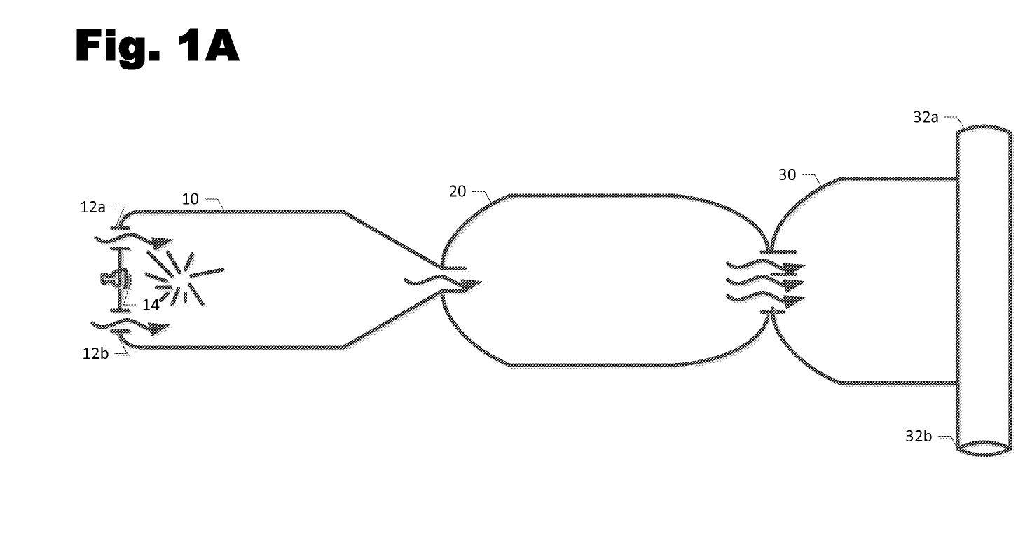

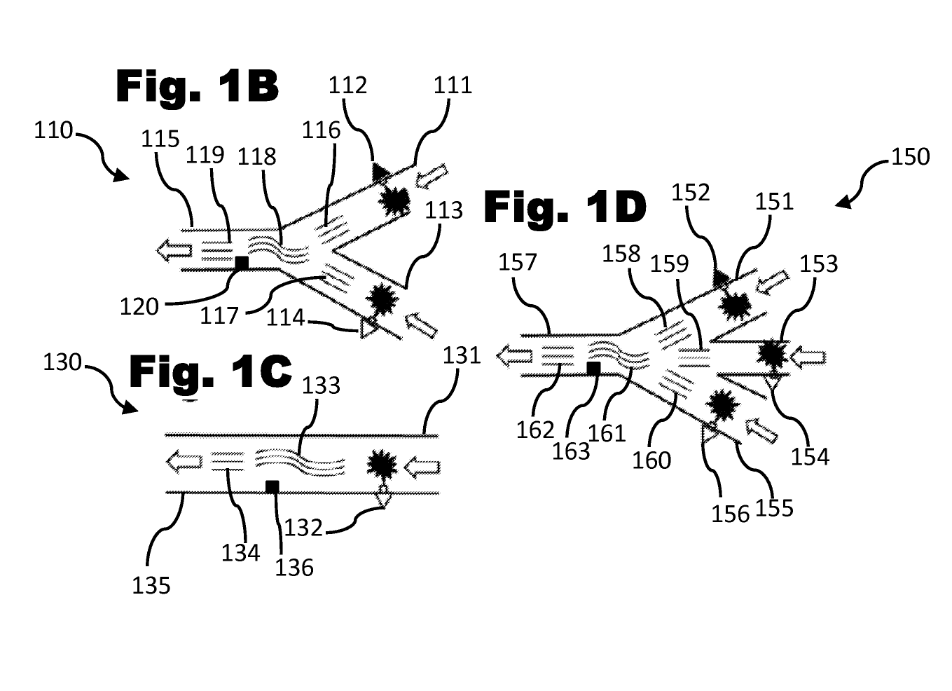

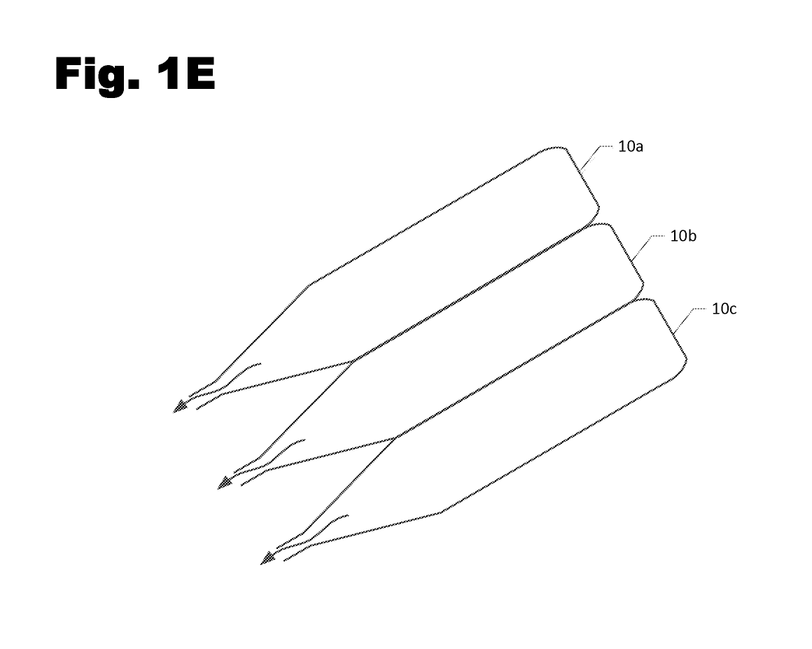

FIGS. 1A-E illustrate cross-sectional views of example resonance combustion chambers. In FIG. 1A, a combustion chamber 10 is shown having inlet ports 12a-b and an igniter 14. In an example, the combustion chamber 10 may be connected to a second chamber 20, e.g., a heated, low-pressure chamber. The second chamber 20 may be provided for reversible reactions driven favorably by heat, but not pressure (e.g., urea production). A cooling chamber 30 may be provided for collection of gases and aqueous solutions.

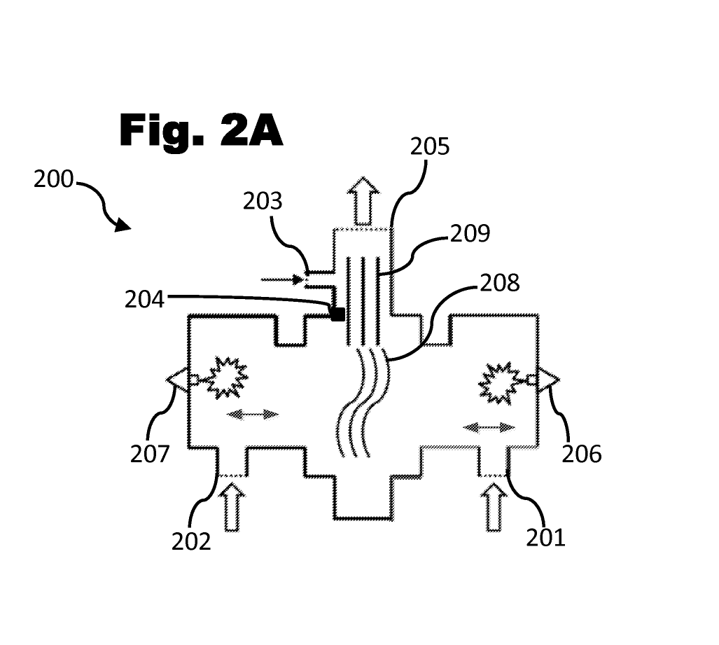

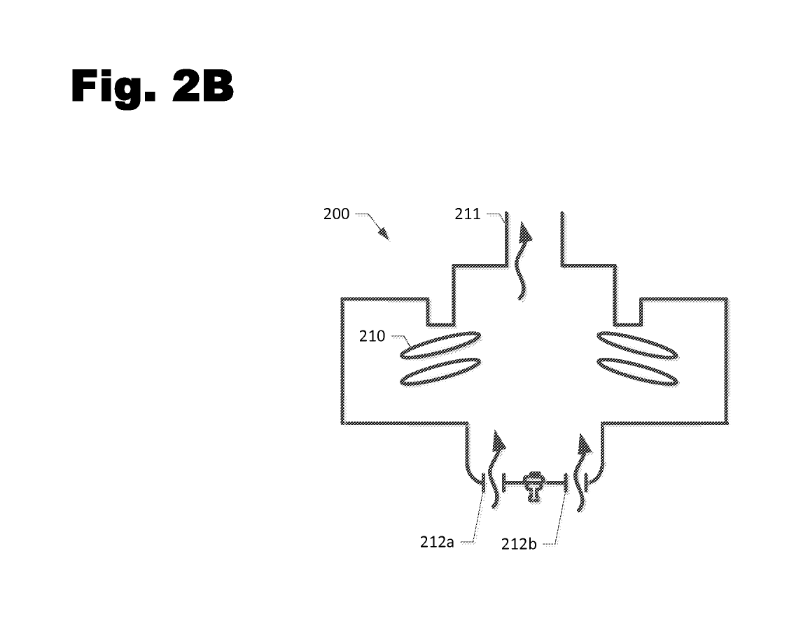

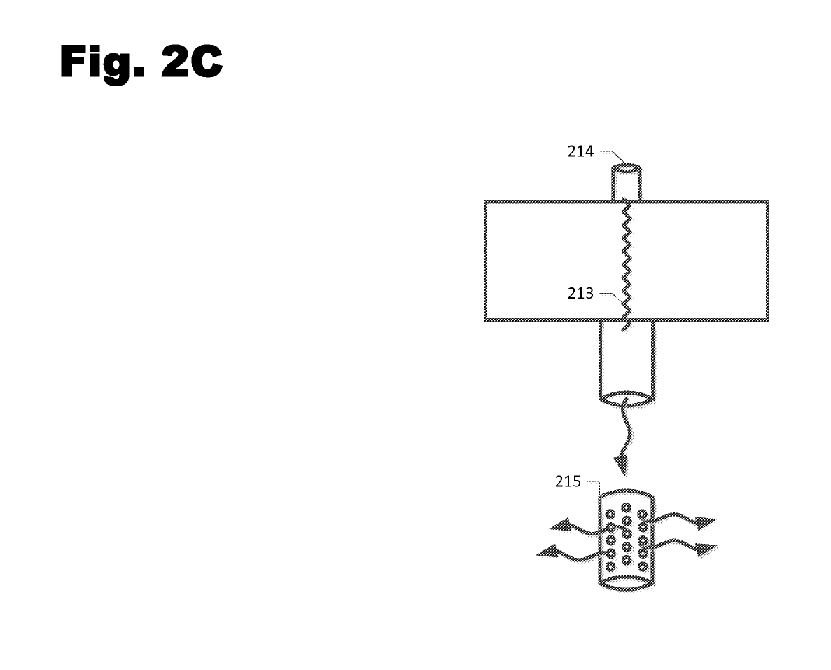

FIGS. 1B-E and FIGS. 2A-C illustrate other example operating environments. It is noted, however, that the system described herein is not limited to any particular structure, and the figures are provided only for purposes of illustrating various example operating environments which may be implemented by the system described herein.

In an example, during operation water vapor and chemical substrates such as ambient air, hydrogen, oxygen and nitrogen as well as carbon monoxide or carbon dioxide or other nitrogenous or carboniferous oxides, hydrides or hydrocarbons or combinations of these are injected into a chamber at high pressure and/or high temperature so as to strike a standing shock wave induced or created by a reflection of the energy of a high pressure, high temperature detonation within the steam and substrates.

Nitrogen is fixed with hydrogen and/or oxygen to produce ammonia, ammonium nitrate, nitric acid, nitric oxide and other nitrogenous oxides and hydrides. The nitric oxide produced is then directed into a chamber containing water vapor as mist, steam or superheated steam. This water vapor rapidly converts the nitric oxide to nitrogen dioxide which, in turn, absorbs into water as nitric acid. This conversion can be adjusted to produce ammonia which may be combined with the nitric acid to produce ammonium nitrate. In another example, sulfuric acid may be produced by introducing hydrogen sulfide gas into the process. Hydrogen and oxygen reactants may be provided by electrolysis or other dissociation of water such that no hydrocarbon energy is required. The introduction of salt (NaCl) water into the chamber under hydrogen rich conditions allows hydrochloric acid (HCl) to be made.

In an example, the ammonia product may be reacted with iron under anaerobic and extreme temperature conditions to yield iron nitrides such as Fe₂N; Fe₃N₁₊ₓ, Fe₄N and Fe₁₂N₂ or iron oxides such as FeO, Fe₃O₄, Fe₄O₅, Fe₂O₃, α-Fe₂O₃, β-Fe₂O₃, γ-Fe₂O₃, ε-Fe₂O₃ as other products of the system. Iron nitrides may be used as catalysts or in the manufacture high-power magnets. Certain iron oxide catalysts also improve chemical production under conditions of lower pressure. Any oxide can be made of any element able to bond with oxygen under conditions of excess oxygen remaining in the high pressure and heat provide by the system herein provided.

In some applications, combustants and chemical reactants may be introduced along with a dense but fine water vapor or other vaporized liquid introduced at high pressure. Such a liquid additive serves to moderate the temperature of the resulting combustion or detonation and regulate cooling of the system. While the system may be used without a vapor, when used, the vapor may further enhance the production or manufacture of ammonium nitrate, ammonia, urea, nitric acid or other products requiring fixing hydrogen to nitrogen. Liquid nitrogen may also be used as a cooling agent in addition to a reactant source. The chemical substrates may be carried by the water vapor. Catalysts may or may not be added according to the results intended. Modeling in shock wave labs has indicated great productive potential for ammonia production at shock wave pressures up to about or exceeding 3,500 bar even without catalyst.

Additionally, urea may be produced by introducing carbon monoxide, carbon dioxide or a combination of these into an outlet stream of gases and fluids. When this stream contains ammonia, it can continue into another heated but low pressure chamber to make urea in a continuous reaction as CO₂ is added. Other chemicals which require high pressures and temperatures for practical commercial production or which require combining nitrogen may also be produced.

Product(s) may be ejected as a propellant, or cooled in a collecting chamber for purposes of chemical conversion of non-combusted substrates from pyrolysis and/or piezolysis. In turn, the detonation may power a continuous, quasi-steady state, or other combination of pressure waves to provide extreme heat and pressure to certain chemical reactions. The detonation and the chemical processes may become self-igniting and continuous.

Another enclosed chamber 30 or vessel attached just beyond the exit nozzle facilitates cooling and condensation of the emerging fluids such as the water admitted as steam, resulting from hydrogen and oxygen combustion or other chemicals which may react under conditions at or near standard temperature and pressure. The ultimate exhaust (e.g., the final discharge of gaseous and liquid products at end of each process at exit ports 32a-b) may include gas(es), gas(es) in aqueous solution and/or fluid products which are dissolved in the water condensed from the introduced mist or the water produced as the result of hydrogen combining with oxygen during detonation.

Heat and pressure are created as an integral part of nitric acid production. After nitric acid production with low pressure deflagration, the system may be adjusted, for example through variable and controllable nozzling and porting, to produce detonations. Repetitive opposing or directionally combined detonations of hydrogen and oxygen are used to produce supersonic flows. The supersonic flows drive the nitric acid deeper into the rock structures, add heat and pressure, and combine shock and acoustic waves to thereby improve the release of petroleum.

In an example, the system includes a durable combustion chamber 10 (e.g., made of steel, iron or other durable material) into which hydrogen, oxygen and nitrogen are admitted and combusted. The combustion chamber 10 may be configured for reverberation of multiple shockwaves and prolongation of echoes to create multiple collision points and provide maximal prolongation and force of shock waves. Colliding detonations during operation create an intermittent “standing wave” in a region along a path through the chambers. This wave may be configured to be substantially parallel (FIG. 1C), substantially perpendicular (FIG. 2A), or at any of a variety of other angles (FIGS. 1B and 1D) relative to the axis of the chamber. The configurations are not limited to those shown, and the chambers may have any of a variety of sizes, shapes or configurations.

Referring to FIG. 1C, chamber 130 includes a single ignition source 132 which may be provided near inlet 131 to produce a linear flow through chamber 130 and a standing shock wave 133. After chemical reactions at standing shock wave 133, products exit outlet 135 as flow 134. In one example, the length of chamber 110 may be substantially greater than the width or diameter. For example, the length may be 10 times that of the width, diameter or both.

Multiple ignition sources enable adjustment of the flow of gasses when fired in succession. In an example, the resulting gases may be deflected at acute angles to the colliding shock wave fronts (FIGS. 1a and 1c). Timing detonations, partially physically restricting flow or directing shock wave fronts to intersect at acute angles enable a duration of chemical reactions at a nodal point of the wave front collisions to be extended. In this way, more complete reactions may be realized. In an example, the duration of a shock wave is extended by distorting shock wave fronts.

Referring to FIG. 1B, chamber 110 has two ignition systems 112 and 114 provided at respective inlets 111 and 113 to produce flows 116 and 117 intersecting at an acute angle to yield standing shock wave 118. After chemical reactions at standing shock wave 118, products exit outlet 115 as flow 119.

Referring another example illustrated in FIG. 1D, a chamber 150 may be provided to combine more than two combination and directional waves at acute angles. Chamber 150, which has three ignition sources 152, 154 and 156, may include a center enabling the collision point of the multiple flows 158, 159 and 160 to be further directed through chamber 150. Through variable and controllable nozzling and porting of combustive shock and detonation products, chamber 150 may be controlled and/or configured to adjust the speed of flow, thereby increasing the exposure to a catalyst 163 within chamber 150. After chemical reactions at standing shock wave 161, products exit outlet 157 as flow 162

In some applications, the center input port 153 or other input ports 151 or 155 can be used for chemical reactant or water vapor input instead of as an additional combustion wave port.

In another example, a chamber may be provided for two opposing waves rather than two combining waves. FIGS. 2A-C illustrate cross-sectional views of an example opposed twin combustion chamber. In an example, ignition sources 206 and 207, which may take the form of a spark plug or laser, are provided adjacent to the region of standing waves 208. Ignition sources may be provided at opposing ends of the chamber and may produce a single spark or multiple sparks. Since the system may continue to fire in the resonance reflected standing shock wave after initial start-up, ignition sources may only be necessary to start the process. Gases resulting from collision of opposing flows may be deflected at right angles to the colliding shock wave fronts (FIG. 2A) and meet at a central point in chamber 200 creating a substantially stabilized intermittently standing shock wave. The pressure of the mixture is maximized. The resulting gasses are deflected into a portion of the chamber at an angle to the colliding shock wave fronts.

An inlet 203 may be provided at one end of the chamber 200 for input of water vapor under pressure to carry one or more chemical reactants. In an example, a chamber may be provided in an opposed twin configuration having ignition sources 206 and 207. Fluids may be introduced into chamber 200 through forward-pushing inputs 201 or 202. Introduction of fluids may be under pressure such as without a physical valve or under limited pressure such as through a one-way valve which allows entry but closes on combustion so that detonations may be isolated from the apparatus conveying fuel and oxidant located external to the combustion chamber. Suitable one-way valves include but are not limited to flapper valves. Isolation can be accomplished by using a wide range of commercially available injectors. Continuous overpressure in chamber 200 or valves 201 and 202 keeps extraneous rock and other material out of the chamber.

In an example, chamber 200 is configured to adjust the flow character of the gases and liquids within to support mixing of chemicals, to sustain detonation gas pressurization, continuous detonation and standing shock waves thereby maximizing chemical production. The flow may be linear, divided, swirling, chaotic or a combination of these based on the products desired.

As shown in FIG. 2B, the combustion chamber may also be configured to allow the shock to expand into a closed chamber opposite outflow channel 205. A prolonged outflow phase 209 is thereby enabled producing a reflection of the shock wave which adds to the energy of another closely following shock wave. Colliding detonations during operation create an intermittent “standing wave” 208 in a region along a path through chamber 200.

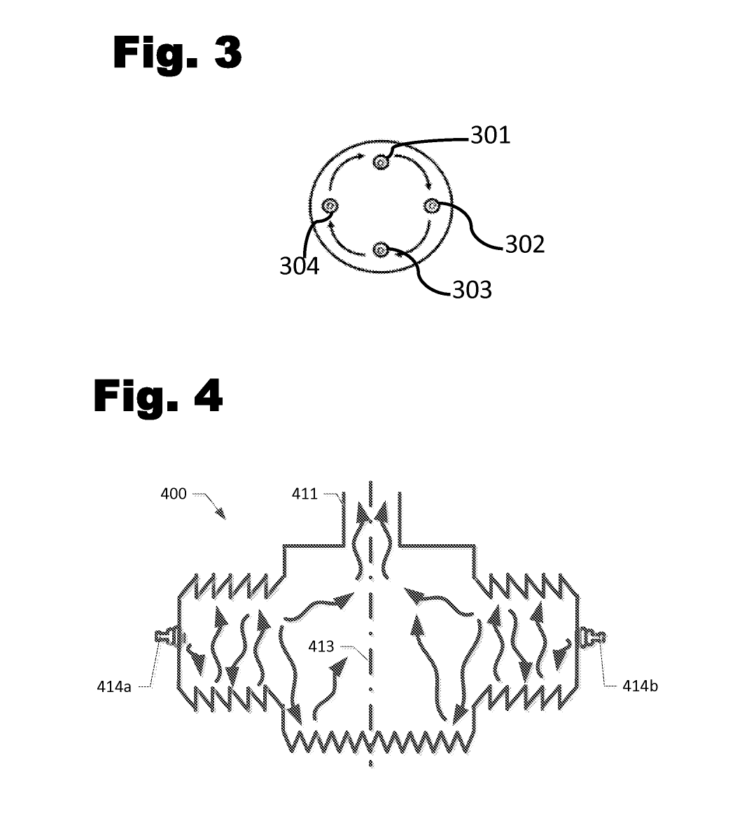

In an example, ignition sources 112, 114, 132, 152, 154 and 156 may take the form of a circular array (FIG. 3) of igniters 301, 302, 303 and 304 which fire sequentially to provide a swirling flow of gasses. This swirling flow may augment chemical mixing and facilitate or expedite the aforementioned chemical reactions. Since the chambers 110, 130, 150 and 200 may continue to fire in the resonance reflected standing shock wave after initial start-up, ignition sources may only be necessary to start the process.

Chambers 110, 130, 150 and 200 may be cooled internally or externally by liquid or gas. In an example, a nozzle may be positioned at the exhaust (exiting at 211 in FIG. 2B) for purposes of creating variable static pressure within the system. This enables adjusting and tuning the resonance of the device to allow a vacuum following each detonation to draw in the following charge of combusting gases and chemical substrates. In some applications, heat energy drawn back into the chamber in this way following ignition will serve to provide ignition energy for the following cycle.

One or more catalysts 120, 136, 163 or 204 may be provided to interior horizontal regions of any or all of the chambers 110, 130, 150 and 200 to initiate processes internal to the chambers and increase efficiency of output. Catalysts may, for example, be positioned adjacent to the standing shock waves 118, 133, or 161 or in another location according to the results desired. For example, catalyst 204 may be positioned adjacent to the standing shock wave 208 or in another location according to the results desired. The flow of reactants across catalyst 204 can be controlled through a plurality of combustion inputs, and/or by arrangement of the input gas flow directions, and/or the amount of swirling that is induced. Catalysts, with or without a supporting structure which is durable and into which they can be embedded. In an example, the catalysts may be located at baffles (210 in FIG. 2B), which may be configured to affect the course and character of the shock and acoustic waves produced.

Any of a variety of catalysts well-suited to the reaction or reactions may be employed within chambers 110, 130, 150 and 200. In some examples, catalysts may be provided as particles of AlO₃, K₂O and CaO, Fe₃O₄, FeₓNₓ, or PI or may include precursors such as KOH, AlOH₂, CaOH, Ca(OH)₂, or Fe(OH)₂. Catalyst precursors including hydroxides such as Al(OH)₃, KOH, Ca(OH)₂ and Fe(OH)₂ may be provided to the chambers. These hydroxides undergo chemically changes into corresponding oxides under conditions of combustion with residual oxygen. It should be noted that, in some example applications, catalysts are not necessary.

In an example, catalysts may be provided (e.g., at inlet 212 and/or outlet 211 in FIG. 2B) in micronized form into the cooling water mist, which is configured to be dissociated into hydrogen and the hydroxyl (OH) group. The mist containing the catalyst may be introduced at the collision point of the shock waves where the chemical reaction occurs and where cooling is needed. By combining the catalyst with the movement of the dissociative cooling reaction in this manner, catalyst exposure time may be increased. Catalysis generally is based at least in part on time the reaction is in contact with the catalyst, but can also be based at least in part on the time the catalyst is provided in the flow of gasses. The length of the chamber may be adjusted based on the flow speed of gasses and the amount of catalysis needed. The catalysts may be recovered from the final aqueous product (exiting at 211 in FIG. 2B) and reused to maximize the surface area of the catalyst.

Again with reference to the combustion chamber, each opposite end may be configured as a reflecting surface that bounces the shock wave(s) back and forth to prolong collision and reverberation. This is illustrated, for example by the double-headed arrows shown on each side of the combustion chamber in FIG. 2A. FIG. 4 is another diagram of an example combustion chamber 400. As shown, the combustion chamber 400 includes at least one ignition source 414a-b, and opposing surfaces configured with zig-zag internal reflective surfaces to reflect the shock waves and enhance reverberation of the shock waves (e.g., as illustrated by the arrows within the combustion chamber 400). In an example, the combustion chamber 400 may be configured with one or more reflective surface to direct the shock waves in a pattern that meets at the midline nodal point 413. Such a configuration concentrates the chemical reaction at the nodal point 413, increasing the energy and pressure at the nodal point 413, and prolonging the chemical reaction prior to exit at port 411. This configuration may further enhance operating efficiencies.

It is noted that the specific configurations may be determined based on the individual dimensions of each combustion chamber and other design characteristics as would be known to those having ordinary skill in the art after becoming familiar with the teachings here.

Generally, the shock waves follow a path through the system within the reverberating confines of the combustion chamber. It is noted, however, that while the drawings show shockwaves traveling a linear path, the shockwaves may not travel in uniform and straight projections, and may instead ‘bounce’ off the reflective surfaces of the combustion chamber. For example, in FIGS. 1B, 1C, and 1D, components 116, 117, 134, 162, 160, 159, 158, and 119 do not always have to be provided in a linear configuration. Different configurations may be provided for reverberation of off the walls during travel through the system.

In addition, the combustion chamber may be configured with a number of offset opposing surfaces that bounce the shock wave back and forth until it loses energy. This may occur in a very short time (e.g., on the order of microseconds), thus leaving milliseconds for the vacuum to draw fuel back into the device for auto ignition to occur. In an example, operation is consistent with rapid (e.g., 200 Hz or more) pulsations, referred to herein as a “quasi-continuous” operating state.

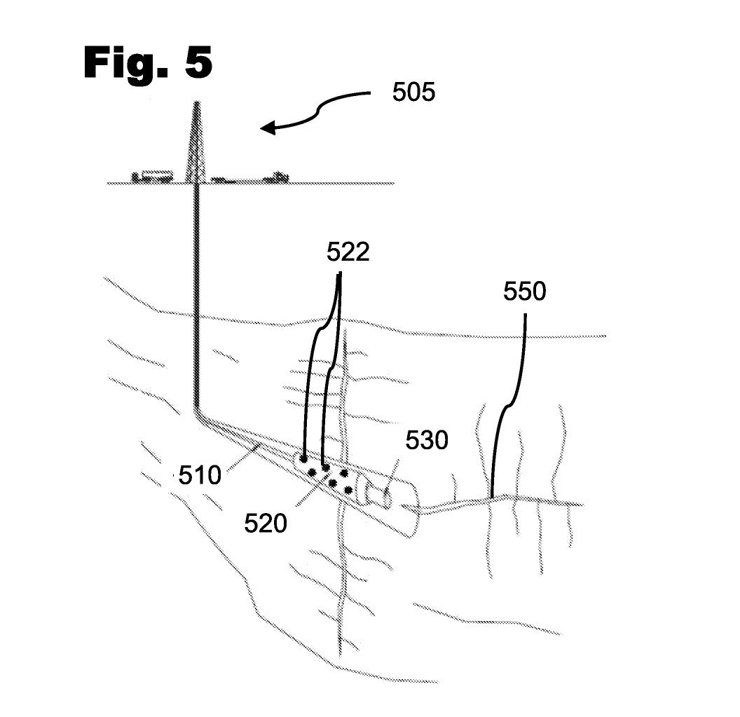

It will be appreciated that the systems described herein may be implemented for any of a variety of different applications. In an example use-case, the systems may be implemented for petroleum and other recoveries from subterranean carbonate and other rock structures. FIG. 5 illustrates an example use case of the systems and methods described herein to loosen oil and gas deposits in the earth. Although not limiting in use, the systems and methods may be used to combine supercritical water, as well as shock, acoustic energy, static steam pressure, and/or extreme temperatures in a confined subterranean location.

Repetitive ignition synthesizes shock and acoustic waves with supercritical water. Supercritical water can be used to dissolve hydrocarbons in-situ and/or affect their viscosity facilitating extraction of heavy oil and oil sands.

Hydrogen, methane, or hydrocarbon powered system provided with or without steam is configured for shock fracturing in underground structures containing hydrocarbon. Hydrogen, methane, or other hydrocarbon, an oxidant and water are delivered from a surface based source 505 through a conduit 510 to chamber 520 for fueling the process.

Chamber 520, which may take on any of structure (e.g., the examples described above), may be inserted into or create an underground cavity creating a retort to produce hydrocarbons from petroleum or syngas in coal or peat deposits. Once underground, chamber 520 burns hydrogen and oxygen in a continuous flame, without detonation. Water mist is then introduced into the chamber with resulting steam at a temperature above about 374 degrees Celsius. Nitric acid produced by the chamber is driven into rock structures by detonations with or without water mist for a thermal de-polymerization method of thinning and partially or fully refining petroleum, in situ, in subterranean structures.

After chemical reactions within chamber 520, products exit outlet 530. The resultant enables fracture creation and expansion, spalling to hold fissures 450 open, as well as loosening and liquefication of oil, gas, and coal deposits. Inclusion of directional ports and/or perforations 522 allow outward expansion of explosive forces. Forward pushing ports (e.g., ports 201 and 202 in FIG. 2A) may also be provided to chamber 520.

Chamber 520 may also be configured to allow passage of rock rubble and hydrocarbonated material there behind as it is moved from the well. Many applications allow for a single or intermittent use mode as well as a continuous use mode enabling creation of energy for continuous fracturing, fissuring, and spalling.

A well casing, a drilled section of formation or both may be used as a combustion or detonation chamber through use of packing systems. Multiple combustion chambers may be included lined up next to one another (e.g., chambers 10a-c shown in FIG. 1D) in the borehole with all directions shooting in unison or otherwise. A variation in timing of each chamber may be used to create a resonance and push the gas or pressure driven liquid from the well out in waves as a liquefied product. The gaseous or liquefied product may be directed to pass nearby the chamber where the high temperature and pressure in an oxidant free environment, allows the breaking and shortening of hydrocarbons nearby.

Tuning the rate of shocks produces reverberations and enhances seismic waves, which also enhance chemical bond disruption, as well as in disruption and fissuring of mineral structures. Modeling and testing of proof of concept device shows production of lengthy fissures which increase rock permeability.

In another example, solid materials including sand and ceramics as well as materials of composite construction can be entrained at or into the nodal point or stream of nodal points along the continuum of the shockwave pathway (209 in FIG. 2A) to modify the solid material with thermal energy and extremely high pressures. As an example, the structure of sand or similar material may be altered to produce a porous filtering material allowing the passage of water, or other liquids or gases there through. Precisely controlled sintering, melting, or fusion of the materials may also be achieved, as desired.

In another application, water; solutions or suspensions of nitrates, urea or other chemicals having larger than water molecules; or other liquids, are introduced and entrained into the stream of combustive gases, or their exhaust. The result is ejected as a gas carrying vaporized water along with larger particles, smaller particles or both. This ejecta, under extreme resultant pressure of combining static, shockwave, and acoustic wave pressures, is directed into another continuing chamber (e.g., chamber 214 shown in FIG. 2C) containing material with pores small enough to exclude passage of materials larger than water molecules and/or other molecules not wished to be removed from the filtered water and durable enough to withstand the heat and pressures involved. Suitable porous materials may include membranes, membranous fibers, fullerene, graphene nanotubes or other material with appropriately sized pores forced through the membrane (215 in FIG. 2B) by the extreme resultant pressure, the eject filters into purified water, along with other selected larger molecules, if desired. Meanwhile, other chemicals such as sodium chloride, ammonium nitrate and urea are prevented from passing. Certain chemicals may thereby be concentrated in aqueous solution or suspension and/or carried in particles of water vapor. Water may be purified by the removal of other materials or pollutants and may be desalinated by the removal of common sodium chloride or other types of salt.

The systems and methods may also be used to liquefy kerogen for removal from oil sands in-situ as well as be implemented in deep coal structures. The systems and methods are capable of being either subsonic or supersonic to produce spalling and cracking and utilize the violent, but controlled, detonations to open the fractures. The systems and methods utilize repeated shocks to fracture the shale or other hydrocarbon containing structure, making proppant from particles of rock spalled off the fissure interfaces to prevent fractures from closing back up and allowing a conductive path back to the wellbore for desired hydrocarbon extraction. Proppant may also be introduced from surface and entrained in the detonation shockwave pathway for placement into the formation.

Through variable and controllable nozzling and porting of combustive shock and detonation products, chamber 500 can direct force in any desired direction as well as be used to push, steer, and drive the chamber and detonation pressures through shale formations. This can be particularly useful in deep tar sand structures and disrupted shale beds in areas of tectonic activity.

Continuous operation of chamber 500 creates static pressure in the well comparable with current hydraulic fracking pressures (e.g., about 10,000 psi) while adding conducted heat, acoustic waves, and directional shockwaves providing for a rapid and dynamic pressure pulsing not previously achieved. In continuous operation, accumulating water from that used to cool the device and/or that derived from combustion as well as liquid and gaseous hydrocarbons in the rock structure itself also conduct shock and acoustic waves to increase the hydraulic shock of each blast without themselves being consumed.

Disclosed chambers may also be employed to mine gold and platinum when configured to make nitric acid since combining the nitric acid with hydrochloric acid yields aqua regia capable of dissolving these metals. The force of the detonation shock waves fractures rock containing the metallic deposits as gas and acid are driven into precious metal bearing seams. Gold and platinum may later be recovered from the resulting acidic solution.

The system may also be configured for use in continuous feed sterilization and material processing.

While the system has been presented with respect to specific examples, it will be appreciated that many modifications and changes may be made by those skilled in the art without departing from the spirit and scope of the claims.

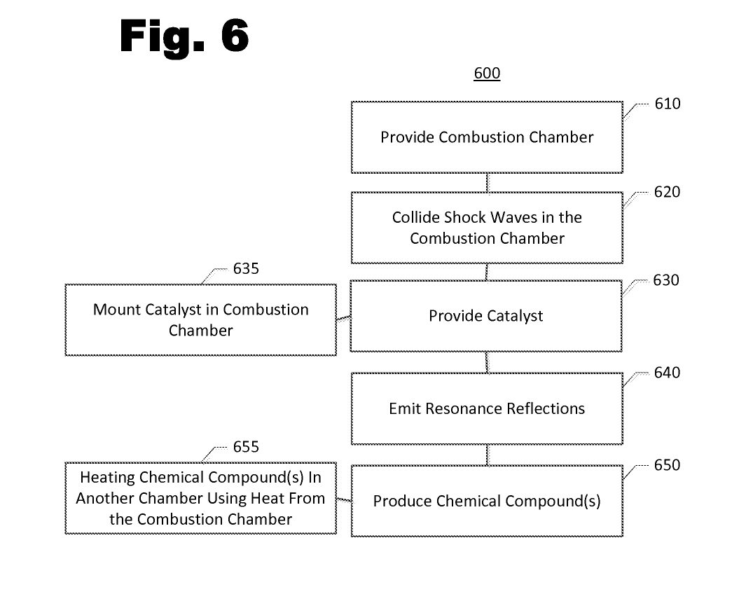

FIG. 6 is a process flow diagram illustrating an example method which may be implemented by the system described herein. In this example, a method 600 is illustrated for using high enthalpy colliding and reverberating shock pressure waves for chemical and material processing. The method includes providing 610 a combustion chamber including at least one inlet and at least one outlet, and an ignition source. The method also includes colliding 620 reflected or opposing combustion-induced or detonation-induced shock wave fronts within the combustion chamber. In an example, colliding creates an intermittent standing wave of pressure and/or shock waves.

In an example, the duration of a shock wave can be extended. For example, the shock wave duration may be extended by distorting shock wave fronts to enable a duration of chemical reactions at a nodal point (e.g., 213 in FIG. 2C) of wave front collisions so that reactions continue to completion. Also in an example, particles of solids or nutrients may become entrained in a shockwave pathway for structural modification, thermal processing, pressure processing, material sterilization, and nutrient preparation.

The method may also include providing 630 a catalyst in the combustion chamber. In an example, the catalyst is configured to affect chemical processing and direct flow of liquid or gas. The method may also include mounting 635 a catalyst (e.g., on a holder) in the combustion chamber through which a coolant is provided into a chemical pathway of the combustion chamber. The method may also include emitting 640 resonance reflections from the combustion chamber to focus pressure at a catalyst provided at the interior of the combustion chamber. In an example, emitted resonance reflections cause self-ignition.

The method may also include continuously producing 650 ammonia, ammonium nitrate, nitric acid, and urea. The method may also include heating 655 a chemical compound synthesized in another connected chamber using heat from the combustion chamber to make another chemical compound in an extended reaction.

It is noted that the examples shown and described are provided for purposes of illustration and are not intended to be limiting. Still other examples are also contemplated.

1. A system for utilizing high enthalpy colliding and/or reverberating shock pressure waves and detonation gasses for dynamic pressurization, the system comprising:
a combustion chamber including at least one inlet and at least one outlet;
an ignition source to generate the high enthalpy colliding and reverberating shock pressure waves and detonation gasses.

2. The system of claim 1, further comprising spatially separable areas of chamber for the introduction of other or additional chemical substrates or catalysts.

3. The system of claim 1, further comprising at least one catalyst to enhance a reaction in the combustion chamber.

4. The system of claim 3, wherein the catalysts are introduced to the combustion chamber in a micronized form as precursors of the catalysts, the precursors converted to the catalysts by heat and pressure of combustion in the combustion chamber.

5. The system of claim 1, further comprising a second chamber following the combustion chamber in a linear, perpendicular, angular, or opposed configuration to direct the flow of gasses.

6. The system of claim 5, wherein the second chamber is configured to change a temperature of the effluent from the combustion chamber.

7. The system of claim 1, wherein particles of solids or nutrients are entrained in a shockwave pathway for structural modification, thermal processing, pressure processing, material sterilization, nutrient preparation, or externally supplied proppants.

8. The system of claim 1, wherein water carrying larger molecules is entrained into a stream of shockwave pressure, and heat produced by combustion provides a force to separate the water from unwanted chemicals via filtration through a durable membrane.

9. The system of claim 1, wherein duration of a shock wave is extended by distorting shock wave fronts by timing detonations, partially physically restricting flow, or directing the shock wave fronts to intersect at acute angles, thereby enabling a duration of chemical reactions at a nodal point of wave front collisions to be extended.

10. The system of claim 1, wherein the combustion chamber is configured as a gold and platinum mining device by detonating hydrogen with oxygen and nitrogen to make nitric acid, or aqua regia when hydrochloric acid is externally added or produced in the process itself.

11. The system of claim 1, further comprising providing hydrogen with carbon containing fuel and oxidant to turn carbon into graphite, carbon fullerene, or graphene nanotubes to act as a proppant.

12. A method for using high enthalpy colliding and/or reverberating shock pressure waves for chemical and material processing comprising:
providing a combustion chamber including at least one inlet and at least one outlet;
colliding wave fronts within the combustion chamber.

13. The method of claim 12, further comprising continuously producing ammonia, ammonium nitrate, nitric acid, and urea.

14. The method of claim 12, further comprising providing a catalyst in the combustion chamber, the catalyst configured to affect chemical processing and direct flow of liquid or gas.

15. The method of claim 12, wherein colliding creates an intermittent standing wave of pressure.

16. The method of claim 12, further comprising emitting resonance reflections from the combustion chamber to focus pressure at a catalyst provided at the interior of the combustion chamber.

17. The method of claim 12, further comprising mounting a catalyst on a holder in the combustion chamber through which a coolant is provided into a chemical pathway of the combustion chamber.

18. The method as set forth in claim 12, further comprising heating a chemical compound synthesized in another connected chamber using heat from the combustion chamber to make another chemical compound in an extended reaction.

19. The method of claim 12, wherein the duration of a shock wave is extended by distorting shock wave fronts to enable a duration of chemical reactions at a nodal point of wave front collisions.

20. The method of claim 12, wherein particles of solids or nutrients are entrained in a shockwave pathway for structural modification, thermal processing, pressure processing, material sterilization, and nutrient preparation.
